(19) United States
(12) Patent Application Publication
(10) Pub. No.: US 2015/0139683 A1
(43) Pub. Date: May 21, 2015

(54) DEVELOPING DEVICE, PROCESS CARTRIDGE, AND IMAGE FORMING APPARATUS

(71) Applicant: CANON KABUSHIKI KAISHA, Tokyo (JP)

(72) Inventor: Kojiro Yasui, Numazu-shi (JP)

(21) Appl. No.: 14/546,716

(22) Filed: Nov. 18, 2014

(30) Foreign Application Priority Data
Nov. 20, 2013 (JP) 2013-240143

(51) Int. Cl. G03G 15/08

(52) U.S. Cl. CPC G03G 15/081; G03G 2221/183
USPC 399/102; 399/284

(57) ABSTRACT

A developing device includes a developer bearing member, a developer regulating member, and a space ensuring member. The space ensuring member includes a maintaining unit configured to maintain the space between the image bearing member and the developer bearing member, a rotation regulating portion configured to prevent the space ensuring member from moving, and a cover portion disposed to be not in contact with a surface of the developer bearing member and configured to cover a part of the developer bearing member. The cover portion is configured to cover at least part of an area in which the developer bearing member faces the image bearing member in a rotational direction of the developer bearing member, the area being on an outer side than an end portion of the developer regulating member in a longitudinal direction of the developer bearing member.

### BACKGROUND OF THE INVENTION

1. Field of the Invention

The present invention relates to a developing device that develops a latent image formed on an image bearing member, a process cartridge that attaches to and detaches from an apparatus main body of an image forming apparatus, and an image forming apparatus that forms an image on a recording medium.

The image forming apparatus includes an electrophotographic copying machine and an electrophotographic printer (for example, a laser beam printer, a light emitting diode (LED) printer, and the like), a facsimile machine, a word processor, and the like that employ an electrophotographic image forming process.

2. Description of the Related Art

Conventionally, a developing device is used for developing a latent image, formed on a photosensitive drum by a developer, in an image forming apparatus employing an electrophotographic image forming process.

In such a developing device, a developing blade is disposed on a developing roller as a developer bearing member. Furthermore, a seal member is disposed on an end portion of the developing roller in a longitudinal direction. The developing blade serves as a developer regulating member that regulates a thickness of a layer of the developer. The seal member prevents the developer from leaking in the longitudinal direction.

In the developing device, a gap between the developing blade and the seal member in the longitudinal direction might include an area where the thickness of the layer is not regulated by the developing blade. Thus, the developer in this area might be accidentally transferred onto the photosensitive drum. When this happens, an image defect (end portion fogging), in the form of a black streak, might occur in an end portion of a paper sheet (recording medium) in a direction orthogonal to a feed direction. The fogging basically means that the developer is attached to an unintended portion. The end portion fogging is the fogging occurring in the end portion of the recording medium.

A technique for preventing the end portion fogging have been discussed in Japanese Patent Application Laid-Open No. 2003-255702 and Japanese Patent No. 3403094. Specifically, for example, the developer not passing through the developing blade is scraped by a scraper and is prevented from being developed on a drum.

### SUMMARY OF THE INVENTION

In view of the problem described above, the present invention is directed to providing a developing device, a process cartridge, and an image forming apparatus that are capable of preventing fogging from occurring outside a developer regulating member.

According to an aspect of the present invention, a developing device includes a developer bearing member configured to carry a developer for developing a latent image formed on an image bearing member, a developer regulating member configured to regulate an amount of the developer carried by the developer bearing member, and a space ensuring member configured to define a space between the image bearing member and the developer bearing member. The space ensuring member includes a maintaining unit configured to maintain the space between the image bearing member and the developer bearing member by being in contact with the image bearing member, a rotation regulating portion configured to prevent the space ensuring member from moving in a rotational direction of the developer bearing member, and a cover portion disposed to be not in contact with a surface of the developer bearing member and configured to cover a part of the developer bearing member. The cover portion is configured to cover at least part of an area in which the developer bearing member faces the image bearing member in the rotational direction of the developer bearing member, the area being on an outer side than an end portion of the developer regulating member in a longitudinal direction of the developer bearing member.

Other aspects of the present invention include a process cartridge and an image forming apparatus including the developing device.

Further features of the present invention will become apparent from the following description of exemplary embodiments with reference to the attached drawings.

### BRIEF DESCRIPTION OF THE DRAWINGS

FIG. 1 is an explanatory diagram illustrating a configuration of a space ensuring member according to an exemplary embodiment.

FIG. 2 is a cross-sectional view illustrating a configuration of an image forming apparatus according to an exemplary embodiment.

FIG. 3 is a cross-sectional view of a process cartridge according to an exemplary embodiment.

FIG. 4 is a cross-sectional view illustrating a configuration of the space ensuring member according to an exemplary embodiment.

FIG. 5 is a perspective view illustrating the configuration of the space ensuring member according to an exemplary embodiment.

FIG. 6 is a cross-sectional view of the space ensuring member according to an exemplary embodiment.

FIG. 7 is an explanatory diagram illustrating a configuration in a longitudinal direction according to an exemplary embodiment.

FIGS. 8A and 8B are perspective views each illustrating a configuration of a space ensuring member according to an exemplary embodiment.

FIG. 9 is an explanatory diagram illustrating the configuration according to an exemplary embodiment in the longitudinal direction.

FIG. 10 is a cross-sectional view illustrating the configuration of the space ensuring member according to an exemplary embodiment.

### DESCRIPTION OF THE EMBODIMENTS

A first exemplary embodiment of the present invention will be exemplarily described in detail with reference to the drawings. It is to be noted that the scope of the present invention is not limited to the size, material, shape, and relative arrangement of components described in this exemplary embodiment, unless otherwise noted. The material, shape, and the like of components once described in the following description are the same throughout the remaining part of the description, unless particularly redefined.

In the description below, a “longitudinal direction” is an axial direction of a developing roller 10d (a direction parallel to the axis of the developing roller 10d) unless otherwise noted.

### (Description on Entire Electrophotographic Image Forming Apparatus)

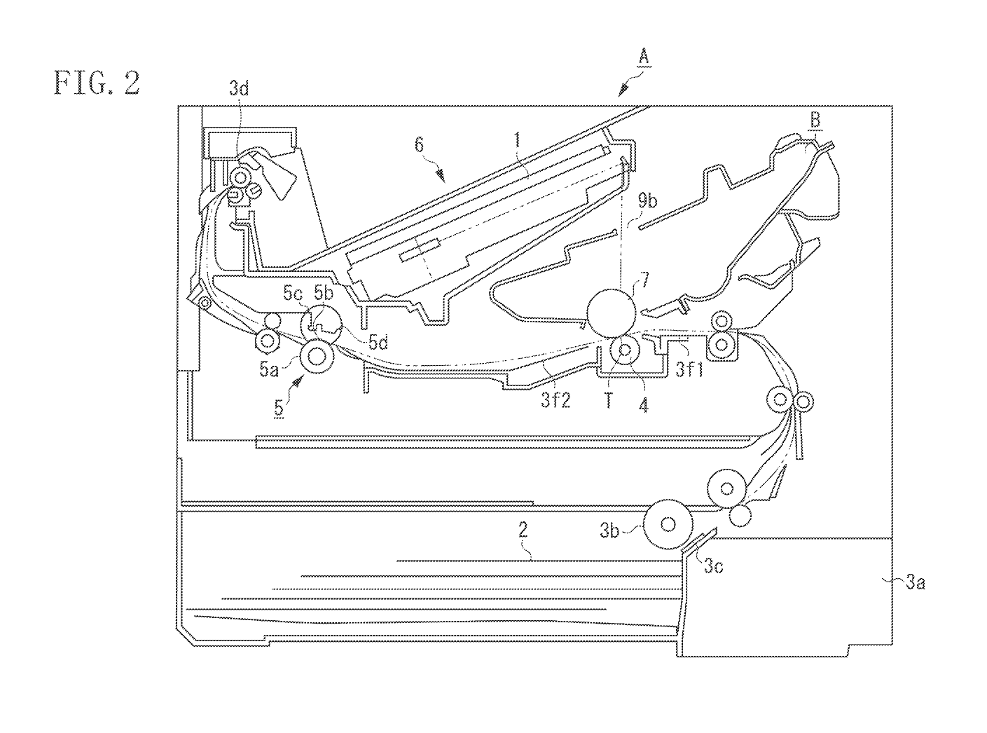

First of all, the configuration of an entire electrophotographic image forming apparatus (hereinafter, referred to as “image forming apparatus”) will be schematically described with reference to FIG. 2. FIG. 2 is a schematic cross-sectional view of an image forming apparatus, according to the present exemplary embodiment, having a process cartridge B installed. More specifically, FIG. 2 is a schematic cross-sectional view of a laser beam printer as one type the image forming apparatus. The process cartridge B is detachably attached to an apparatus main body of the image forming apparatus, and includes a photosensitive drum 7 (image bearing member) and a process unit that performs processing on the photosensitive drum 7. The apparatus main body is a configuration of the image forming apparatus without the process cartridge B.

As shown in FIG. 2, the image forming apparatus (laser beam printer) A according to the present exemplary embodiment irradiates the photosensitive drum 7 having a drum shape with information light, based on image information, from an optical system 1 as an optical unit. Thus, a latent image (electrostatic latent image) is formed on the photosensitive drum 7. The electrostatic latent image is developed by a developer (toner), whereby a toner image is formed. Separation feeding of a recording medium 2 is performed one sheet at a time from a cassette 3a by a pickup roller 3b and a pressing member 3c. The pressing member 3c comes into pressure contact with the pickup roller 3b. The separation feeding and the toner image forming are performed in synchronization. The recording medium 2 having a surface on which an image is to be formed, is usually a recording sheet. Alternatively, a medium other than a paper sheet such as an overhead projector (OHP) sheet and a fabric may be used, depending on the configuration of the image forming apparatus A.

The recording medium 2 thus fed is conveyed along a conveyance guide 3f1 to a transfer unit T. In the transfer unit T, the photosensitive drum 7 and a transfer roller 4 as a transfer unit face each other.

In the transfer unit T, the transfer roller 4 to which a voltage is applied transfers the toner image formed on the photosensitive drum 7 onto the conveyed recording medium 2. Then, the resultant recording medium 2 is conveyed to a fixing unit 5 along a conveyance guide 3f2.

The fixing unit 5 includes a driving roller 5a and a fixing rotating member 5d. The fixing rotating member 5d is equipped with a heater 5b and is formed of a cylindrical sheet rotatably supported by a supporting member 5c. The fixing unit 5 applies heat and pressure to the recording medium 2 passing through the fixing unit 5, so that the transferred toner image is fixed.

A discharge roller 3d conveys the recording medium 2 with the toner image thus fixed, so that the recording medium 2 is discharged onto a discharge unit 6 through a reversing conveyance path. In the present exemplary embodiment, a pickup roller 3b, a pressing member 3c, the discharge roller 3d, and the like form a conveyance unit (conveyance mechanism). The conveyance unit is a unit (mechanism) that conveys the recording medium 2.

### (Process Cartridge)

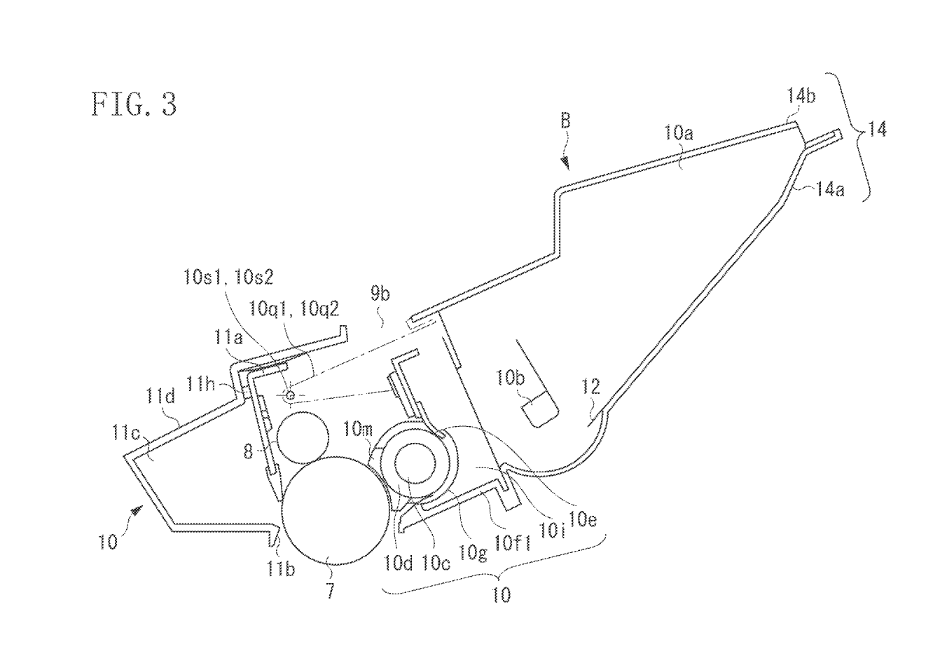

A configuration of the entire process cartridge B will be schematically described with reference to FIGS. 2, 3, and 6. FIG. 3 is a schematic cross-sectional view illustrating the process cartridge B according to the present exemplary embodiment.

As illustrated in FIG. 3, the process cartridge B includes at least the photosensitive drum 7 (image bearing member) and at least one process unit that performs processing on the photosensitive drum 7. A process included in the process cartridge B includes, for example, a charging unit (charging member) that charges the photosensitive drum 7, a cleaning unit (cleaning member) that cleans the remaining toner on the photosensitive drum 7, and the like.

The process cartridge B according to the present exemplary embodiment includes a drum unit 11 including the photosensitive drum 7 and a developing unit 10 including the developing roller 10d (developer bearing member). The drum unit 11 includes a cleaning blade 11a as a cleaning unit (cleaning member), a charging roller 8 as a charging unit (charging member), and a drum frame member 11d incorporating the components. The developing unit 10 includes a developing frame member 10f1 that rotatably supports the developing roller 10d and a toner frame member 14 forming a toner chamber 10a containing the toner as the developer. The developing frame member 10f1 and the toner frame member 14 are coupled to each other to form a frame member of the developing unit 10.

The process cartridge B according to the present exemplary embodiment rotates the photosensitive drum 7 including a photosensitive layer and applies a voltage to the charging roller 8 as the charging unit. Thus, the surface of the photosensitive drum 7 is uniformly charged. The charged photosensitive drum 7 is exposed to the information light (light image), based on the image information, from the optical system 1 through an exposure opening 9b, as illustrated in FIG. 2. Thus, an electrostatic latent image is formed on the surface of the photosensitive drum 7. The electrostatic latent image is developed by the developing unit 10.

In the developing unit 10, a rotatable developer conveying member (hereinafter, referred to as “toner feeding member”) 10b and an elastic sheet 12 feed the toner in the toner chamber 10a as a toner containing unit, into a developing chamber 10i. The elastic sheet 12 comes into contact with the rotating toner feeding member 10b and vibrates.

The developing roller 10d, equipped with a fixed magnet 10c, is rotated and, at the same time, a layer of toner charged by friction by a developing blade 10e as a developer regulating member is formed on the surface of the developing roller 10d. The toner is transferred onto the photosensitive drum 7 in accordance with the electrostatic latent image so that a toner image (developer image) is formed, whereby a visible image is obtained.

A voltage of a polarity opposite to that of the toner image is applied to the transfer roller 4, whereby the toner image is transferred onto the recording medium 2. Then, the remaining toner on the photosensitive drum 7 is scraped off by the cleaning blade 11a, and then picked up by a scoop sheet 11b to be collected into a removed toner container 11c.

As described above, the developing roller 10d is a developer bearing member that carries the developer (toner) for developing the latent image formed on the photosensitive drum 7. The photosensitive drum 7 is an image bearing member on which the latent image is formed and developed. Thus, the photosensitive drum 7 carries the toner image (developer image).

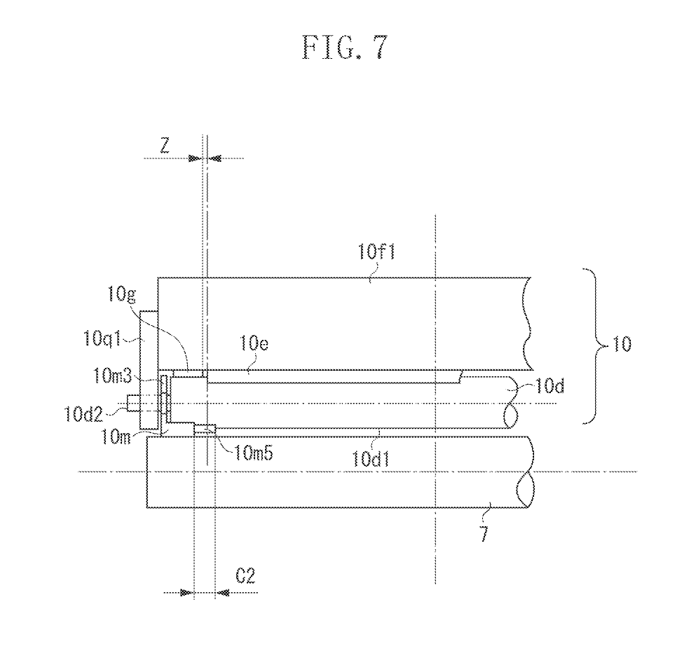

The developing blade 10e is arranged in the longitudinal direction with a gap Z from a seal member 10g provided as illustrated in FIG. 7.

As illustrated in FIGS. 3, 6, and 7, in each of both end portions of the developing roller 10d, the seal member 10g is attached to the developing frame member 10f1. The seal member 10g is provided for preventing the toner from leaking through a gap between the end portion of the developing roller 10d and the developing frame member 10f1. Thus, the seal member 10g prevents the toner from leaking outside of the frame member (the developing frame member 10f1 and the toner frame member 14) of the developing unit 10.

The seal member 10g includes a non-woven fabric and a pile formed of fibers, such as Teflon (registered trademark) and nylon. The toner is held with the seal member 10g which is in contact with the developing roller 10d.

The configuration of the seal member 10g is not limited to that described above. The seal member 10g may be a magnetic member (for example, iron) exerting magnetic force. Thus, the toner may be held by a magnetic field formed between the seal member 10g and the fixed magnet 10c equipped with the developing roller 10d whereby the toner is prevented from leaking. In this configuration, the toner is held by the seal member 10g and the developing roller 10d in a noncontact state.

The seal member 10g is arranged in the longitudinal direction. Specifically, the seal member 10g is disposed in the end portion of the developing roller 10d in the longitudinal direction.

As illustrated in FIG. 3, the developing frame member 10f1 includes arm units 10q1 and 10q2. Coupling holes 10s1 and 10s2 are respectively formed in the arm units 10q1 and 10q2. The drum unit 11 and the developing frame member 10f1 are coupled with each other when a pin is inserted through the coupling holes 10s1 and 10s2. Thus, the developing unit 10 including the developing roller 10d is rotatably supported by the drum unit 11 including the cleaning blade 11a.

With this configuration, the developing unit 10 is relatively movable to the drum unit 11. A spring (not illustrated) is provided between the developing unit 10 and the drum unit 11. Thus, predetermined force f is applied between the developing unit 10 and the drum unit 11, so that the developing roller 10d is urged toward the photosensitive drum 7. As described above, the force of the spring is used as the force f for urging the developing roller 10d toward the photosensitive drum 7. Alternatively, the developing roller 10d may be urged toward the photosensitive drum 7 by its own weight or the weight of the developing unit 10. Thus, the process cartridge B is not limited to the configuration in which the spring is provided.

A spacer 10m (space ensuring member) is disposed in each of both end portions of the developing roller 10d in the longitudinal direction. The spacer 10m defines a space between the developing roller 10d and the photosensitive drum 7. As described below, the spacer 10m maintains a constant space between the respective surfaces of the developing roller 10d and the photosensitive drum 7.

The toner carried by the developing roller 10d jumps from the developing roller 10d to the photosensitive drum 7 by an effect of an electric field formed between the developing roller 10d and the photosensitive drum 7. Thus, the image forming apparatus A of the present exemplary embodiment employs a noncontact developing system (jumping contact system).

(Space Ensuring Member that Ensures a Space Between Developing Roller and Photosensitive Drum)

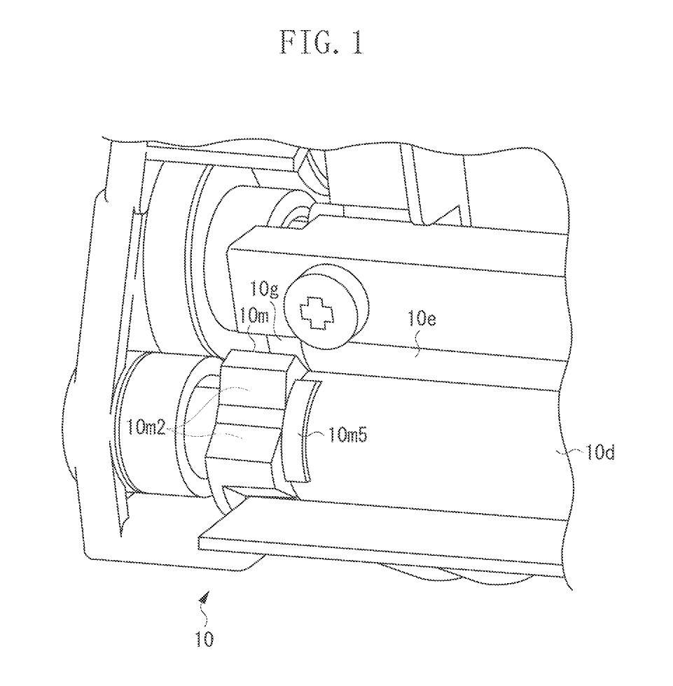

The configuration of the spacer 10m (space ensuring member) is described in detail with reference to FIGS. 1, 4, 6, and 7.

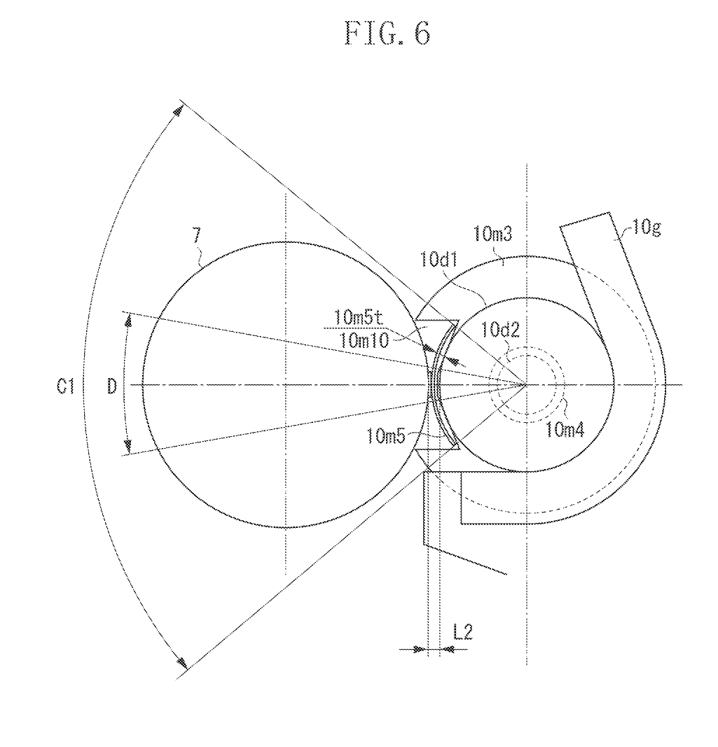

As illustrated in FIGS. 6 and 7, the developing roller 10d includes a large diameter portion 10d1 and a small diameter portion 10d2. The small diameter portion 10d2 is disposed on an outer side of the large diameter portion 10d1 in the longitudinal direction, and is smaller than the large diameter portion 10d1. The large diameter portion 10d1 and the small diameter portion 10d2 are substantially coaxially arranged. The large diameter portion 10d1 is a portion (bearing portion) that carries the toner on its surface. For example, the large diameter portion 10d1 may be formed of an aluminum roller (aluminum sleeve) having a cylindrical shape. In the present exemplary embodiment, the spacer 10m comes into contact with the large diameter portion 10d1 to thereby maintain the space between the developing roller 10d and the photosensitive drum 7 (described in detail later). The small diameter portion 10d2 is a shaft portion (shaft) of the developing roller 10d and is supported by the developing frame member 10f1. Specifically, a bearing included in the developing frame member 10f1 rotatably supports the small diameter portion 10d2, whereby the developing roller 10d is rotatably arranged.

The spacer 10m is formed by injection molding with polyacetal as a material. Other resins such as polyethersulfone, polyphenylene sulfide, or nylon may be appropriately selected as the material of the spacer 10m.

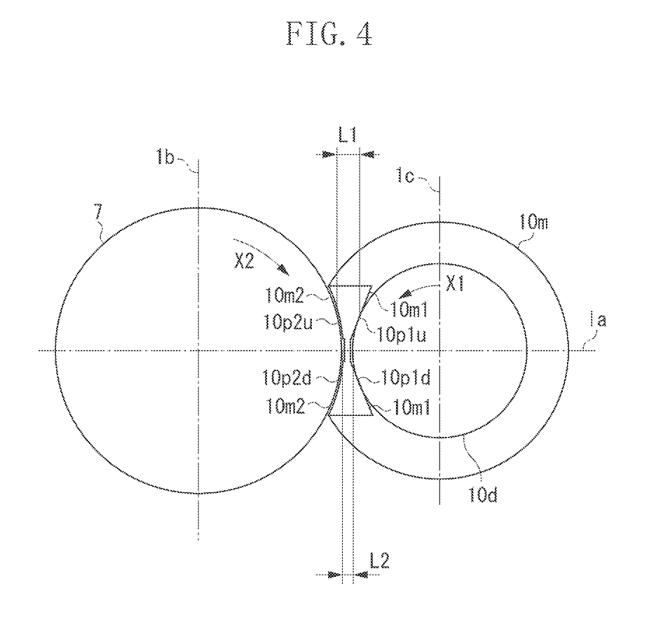

As illustrated in FIGS. 1 and 4, the spacer 10m includes developing roller contact surfaces 10m1 and photosensitive drum contact surfaces 10m2. The developing roller contact surface 10m1 extends along the developing roller 10d. The photosensitive drum contact surface 10m2 extends along the photosensitive drum 7.

The contact surfaces 10m1 and 10m2, which are flat surfaces in the present exemplary embodiment as illustrated in FIG. 4, are not limited to the flat surfaces, and may be curved surfaces.

The arrangement of the developing roller contact surface 10m1 of the spacer 10m in the longitudinal direction is as follows with reference to FIGS. 1, 6, and 7. Specifically, in the longitudinal direction of the developing roller 10d, the contact surface 10m1 is disposed in an area on the developing roller large diameter portion 10d1 facing the seal member 10g.

Developing roller contact portions 10p1 (10p1u and 10p1d) and photosensitive drum contact portions 10p2 (10p2u and 10p2d) are each disposed on opposite sides with respect to a line (straight line) la. The line la connects between the rotational center of the photosensitive drum 7 and the rotational center of the developing roller 10d.

When the circumferential alignment of the photosensitive drum 7 and the developing roller 10d is not aligned in the longitudinal direction, the line la is defined as follows. Specifically, the line la is a line connecting between the rotational center of the photosensitive drum 7 and an arbitrary center of the developing roller 10d in a cross section at an arbitrary position in the longitudinal direction, within a range, in the longitudinal direction of the developing roller 10d, where the spacer 10m is in contact with the photosensitive drum 7 and the developing roller 10d.

The photosensitive drum contact portion 10p2 is disposed on a side closer to the developing roller 10d than a line lb that passes through the rotational center of the photosensitive drum 7 and is orthogonal to the line la.

The developing roller contact portion 10p1 is disposed on a side closer to the photosensitive drum 7 than a line 1c that passes through the rotational center of the developing roller 10d and is orthogonal to the line la.

A distance L1 is provided between the photosensitive drum contact portion 10p2u and the developing roller contact portion 10p1u that are on the upstream side in the rotation direction of the photosensitive drum. The photosensitive drum contact portion 10p2u and the developing roller contact portion 10p1u are disposed more on the upstream side of the line la in a rotational direction of the photosensitive drum 7. The distance L1 is also provided between the photosensitive drum contact portion 10p2d and the developing roller contact portion 10p1d that are on the downstream side. The photosensitive drum contact portion 10p2d and the developing roller contact portion 10p1d are disposed more on the downstream side than the line la in the rotational direction of the photosensitive drum 7. Here, the distance L1 is measured in a direction parallel with the line la. The distance L1 is set to be longer than a distance L2 between closest portions of the photosensitive drum 7 and the developing roller 10d.

Next, an operation of ensuring a space between the photosensitive drum 7 and the developing roller 10d will be described.

As described above, the photosensitive drum 7 and the developing roller 10d are relatively movable with each other. The predetermined pressing force f is applied between the developing unit 10 and the drum unit 11 so that the photosensitive drum 7 and the developing roller 10d are urged toward each other.

The pressing force f brings the developing roller contact portions 10p1 (10p1u and 10p1d) in the developing roller contact surfaces 10m1 of the spacer 10m into contact with the large diameter portion 10d1 of the developing roller 10d, as illustrated in FIG. 4. Here, the photosensitive drum contact portions 10p2 (10p2u and 10p2d) of the photosensitive drum contact surfaces 10m2 are brought into contact with the surface of the photosensitive drum 7. Thus, a predetermined space is maintained between the developing roller 10d and the photosensitive drum 7.

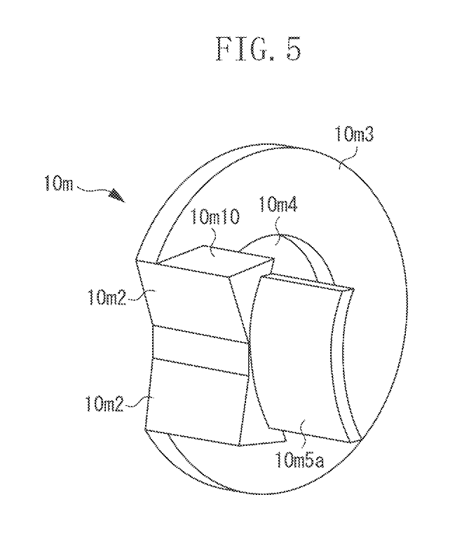

Specifically, the spacer 10m includes a maintaining portion 10m10 (see FIGS. 5 and 6) that is disposed between the developing roller 10d and the photosensitive drum 7 and maintains the distance therebetween. The maintaining portion 10m10 includes the photosensitive drum contact portions 10p2u and 10p2d and the developing roller contact portions 10p1u and 10p1d.

The photosensitive drum contact portion 10p2u is a first image bearing member side sliding portion. The first image bearing member side sliding portion comes into contact with (slides on) the photosensitive drum 7 at a portion disposed more on the upstream side than the line la in the rotational direction of the photosensitive drum 7. The photosensitive drum contact portion 10p2d is a second image bearing member side sliding portion that comes into contact with (slides) the photosensitive drum 7 at a portion disposed more on the downstream side than the line la in the rotational direction of the photosensitive drum 7. Similarly, the developing roller contact portion 10p1u is a first developing side sliding portion. The first developing side sliding portion comes into contact with (slides on) the developing roller 10d at a portion disposed more on the upstream side than the line la in the rotational direction of the developing roller 10d. The developing roller contact portion 10p1d is a second developing side sliding portion that comes into contact with (slides on) the developing roller 10d at a portion disposed more on the downstream side than the line la in the rotational direction of the developing roller 10d.

An operation for preventing the spacer 10m from rotating will be described.

In the present exemplary embodiment, the photosensitive drum 7 rotates in an X2 direction, and the developing roller 10d rotates in an X1 direction. Thus, the photosensitive drum 7 and the developing roller 10d rotate with their facing surfaces moving in the same direction. Therefore, the friction force produced between the spacer 10m and the developing roller 10d and the photosensitive drum 7 forces the spacer 10m to move in the X1 and the X2 directions. Thus, the spacer 10m is provided with a rotation regulation portion (photosensitive drum contact portion 10p2u). Thus, the rotational movement of the spacer 10m in the X1 direction about the developing roller 10d is prevented.

The spacer 10m is disposed with the distance L1 being set to be longer than the distance L2. The distance L1 is provided between the photosensitive drum contact portion 10p2u and the developing roller contact portion 10p1u that are disposed more on the upstream side than the line la in the rotational direction of the developing roller 10d. The distance L2 is provided between the closest portions of the photosensitive drum 7 and the developing roller 10d. The distance L1 is measured in a direction parallel with the line la. The distance L2 is a shortest distance between the surface of the photosensitive drum 7 and the surface of the developing roller 10d and is a distance of the space between the surface of the photosensitive drum 7 and the surface of the developing roller 10d on the line la.

When an image is formed, the pressing force f is applied to the developing roller 10d and the photosensitive drum 7. Thus, the photosensitive drum contact portion 10p2u in contact with the photosensitive drum 7 is unmovable in the X1 and the X2 directions even when the developing roller 10d and the photosensitive drum 7 rotate. Thus, the spacer 10m does not rotate. All things considered, the spacer 10m is prevented from moving in the rotational directions X1 and X2 of the developing roller 10d and the photosensitive drum 7.

As described above, the movement of the spacer 10m in the rotational direction is regulated through the contact between the spacer 10m and the photosensitive drum 7. Therefore, no structure other than the photosensitive drum 7 is required for position regulation of the spacer 10m in the rotational direction X1 or X2.

A configuration and an operation for positioning the spacer 10m in the longitudinal direction will be described.

As illustrated in FIGS. 1, 5, 6, and 7, the spacer 10m includes a longitudinal direction positioning portion 10m3 in an outer direction in the longitudinal direction of the developing roller 10d. The longitudinal direction positioning portion 10m3 includes a hole 10m4 through which the small diameter portion 10d2 of the developing roller 10d penetrates.

As illustrated in FIG. 6, the through hole 10m4 is not in contact with the small diameter portion 10d2 of the developing roller 10d that penetrates the through hole 10m4, in a state where the spacer 10m is positioned by the photosensitive drum 7 and the developing roller 10d. The inner diameter of the through hole 10m4 is larger than the diameter of the small diameter portion 10d2 of the developing roller 10d.

Thus, the through hole 10m4 and the small diameter portion 10d2 of the developing roller 10d do not interfere with each other in the state where the space between the photosensitive drum 7 and the developing roller 10d is maintained by the spacer 10m. Accordingly, the space between the photosensitive drum 7 and the developing roller 10d can be appropriately maintained.

As illustrated in FIG. 7, the longitudinal direction positioning portion 10m3 is disposed between the arm portion 10q1 and a step surface between the large and the small diameter portions 10d1 and 10d2 of the developing roller 10d. Thus, the positioning in the longitudinal direction is achieved.

Next, a configuration for arranging the spacer 10m in the longitudinal direction will be described with reference to FIGS. 5, 6, and 7.

The spacer 10m of the present exemplary embodiment has the maintaining portion 10m10 only between the photosensitive drum 7 and the developing roller 10d as illustrated in FIG. 5. Thus, a space is formed on a side of the developing roller 10d opposite to the maintaining portion 10m10. Therefore, the seal member 10g can be disposed on the opposite side of the maintaining portion 10m10 as illustrated in FIG. 6.

The spacer 10m does not rotate even when the developing roller 10d rotates. Thus, the seal member 10g and the spacer 10m (maintaining portion 10m10 thereof) do not interfere with each other in the circumferential direction.

The spacer 10m is arranged in the longitudinal direction as illustrated in FIGS. 1 and 7. Specifically, in the longitudinal direction of the developing roller 10d, the photosensitive drum contact portion 10p1 forming the maintain portion 10m10 of the spacer 10m overlaps with a seal function surface of the seal member 10g in a center axis direction of the developing roller 10d. The seal function surface is a surface (function portion) that provides a toner sealing property.

As illustrated in FIGS. 1 and 7, the seal member 10g and the spacer 10m can be disposed in the overlapping manner. Thus, the space in which the spacer 10m and the seal member 10g are disposed can be made small, whereby downsizing of the developing unit 10 and the process cartridge B can be achieved.

### (Configuration and Operation of Fogging Preventing Cover Portion)

A configuration of a cover portion 10m5 as a key element of the present invention will be described with reference to FIGS. 5, 6, 7, 8A, and 8B.

As illustrated in FIG. 5, the cover portion 10m5 is integrally formed with other portions of the spacer 10m. Such a spacer 10m can be manufactured by injection molding.

As illustrated in FIG. 7, the cover portion 10m5 has such a shape, in the longitudinal direction, as to cover (be provided over) an area C2 including an entire area of the gap Z between the developing blade 10e and the seal member 10g including an end surface of the developing blade 10e. Thus, the area C2 covered by the cover portion 10m5 includes an entire region between the developing blade 10e and the seal member 10g in the longitudinal direction.

The cover portion 10m5 covers an entire developing area D of the developing roller 10d in the circumferential direction (the rotational direction X1 of the developing roller 10d: see FIG. 4) of the developing roller 10d. Specifically, as illustrated in FIG. 6, the cover portion 10m5 covers (is provided over) a cover area C1 larger than the developing area D in a cross section of the cover portion 10m5 taken along a direction orthogonal to the longitudinal direction of the developing roller 10d.

The developing area D is an area of the developing roller 10d facing the photosensitive drum 7 in FIG. 6 (surface orthogonal to the longitudinal direction). Specifically, in the developing area D, the toner carried by the developing roller 10d is movable from the developing roller 10d to the photosensitive drum 7 when the image is formed. More specifically, in the developing area D, the electric field formed between the developing roller 10d and the photosensitive drum 7 causes the toner to jump from the developing roller 10d to the photosensitive drum 7.

As illustrated in FIG. 6, the cover portion 10m5 is set to have a thickness 10m5t smaller than the distance L2 between the closest portions of the photosensitive drum 7 and the developing roller 10d.

As illustrated in FIG. 6, the cover portion 10m5 is disposed at a position to be in contact with neither the surface of the photosensitive drum 7 nor the surface of the developing roller 10d in the cross section taken along the direction orthogonal to the longitudinal direction of the developing roller 10d.

Next, a material of the cover portion 10m5 will be described. The material used for the cover portion 10m5 is the same as the material of the spacer 10m in the present exemplary embodiment. The material of the cover portion 10m5 is not limited to the material that is the same as that of the spacer 10m, and a different material may also be appropriately selected.

This is because, unlike the spacer 10m that slides on the photosensitive drum 7 and the developing roller 10d, the cover portion 10m5 is not a member that ensures a space between the photosensitive drum 7 and the developing roller 10d. Specifically, the space between the photosensitive drum 7 and the developing roller 10d cannot be maintained when the spacer 10m is worn from being in contact with the photosensitive drum 7 and the developing roller 10d. Thus, the spacer 10m is preferably formed of a wear-resistant material. On the other hand, the cover member 10m5 needs not to be made of the wear-resistant material, and thus may be made of a material different from that of the spacer 10m.

Two-color molding may be employed for the injection molding of different materials in an integrated manner. Thus, with the two-color molding, the cover member 10m5, formed of a material different from that of the spacer 10m, can be integrally formed with a main body of the spacer 10m. The main body of the spacer 10m is a configuration of the spacer 10m without the cover member 10m5. The main body of the spacer 10m includes the photosensitive drum contact portion 10p2u, the photosensitive drum contact portion 10p2d, the developing roller contact portion 10p1u, and the developing roller contact portion 10p1d (the maintaining portion and the rotation regulating portion).

### (Other Configuration of Cover Portion)

The following two configurations are described. These configurations are employed when the distance L2 between the closest portions of the photosensitive drum 7 and the developing roller 10d needs to be set to be small so that the thickness 10m5t of the cover portion 10m5 becomes so small that makes the mass production with injection molding difficult.

In a first configuration, the cover portion 10m5 comes into contact with the photosensitive drum 7 so that the thickness 10m5t of the cover portion 10m5 is set to be large enough to enable the mass production. A configuration in which the cover portion 10m5 comes into contact with the surface of the developing roller 10d cannot be employed. This is because the configuration leads to the scattering of the toner carried by the surface of the developing roller 10d.

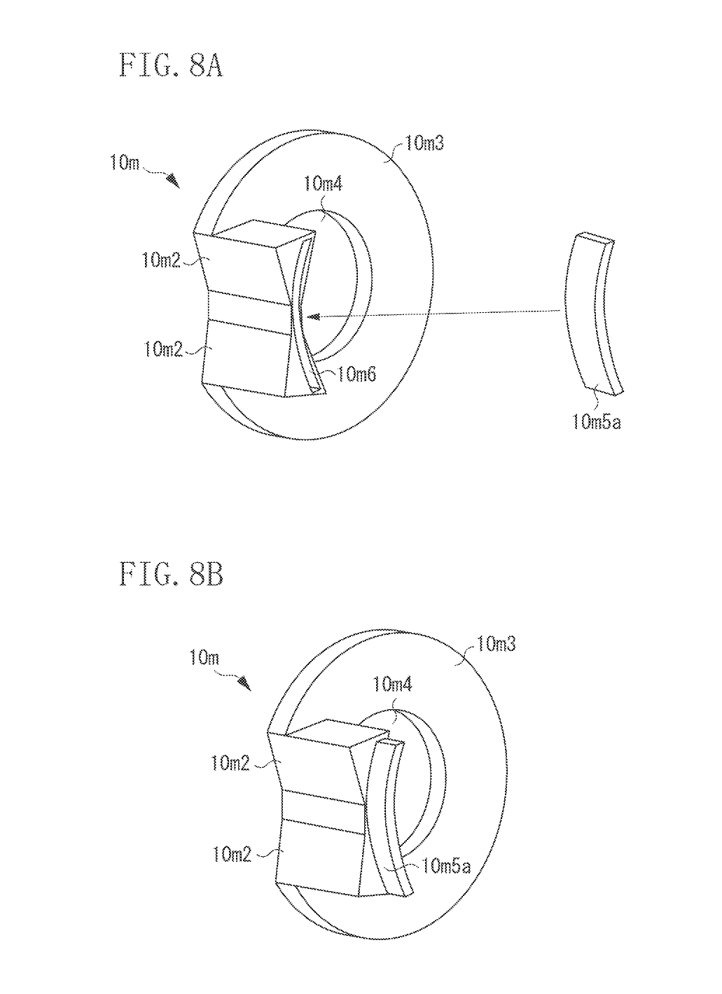

In a second configuration, the cover portion 10m5 is formed as a separate portion (formed as a separate member) with respect to the main body of the spacer 10m, as illustrated in FIGS. 8A and 8B. The cover portion 10m5 formed as the separate portion with respect to the main body of the spacer 10m will be specifically referred to as a cover member 10m5a. A configuration for attaching the cover member 10m5a as the separate portion to the spacer 10m will be described below.

The cover member 10m5a as the separate portion can be made by extrusion molding. The cover member 10m5a can be mass produced with a shape much thinner than the cover portion 10m5 integrally formed with the spacer 10m by injection molding

As illustrated in FIG. 8A, the spacer 10m has a groove portion 10m6. The groove 10m6 has a shape that is substantially the same as the cross-sectional shape of the cover member 10m5a taken along the direction orthogonal to the longitudinal direction of the developing roller 10d. The cover member 10m5a and the groove portion 10m6 have such a dimensional relationship that the cover member 10m5a is press fit in the groove 10m6.

In this configuration, the cover member 10m5a can be attached to the main body of the spacer 10m by being press fit in the groove portion 10m6 as illustrated in FIG. 8B.

In this manner, the cover member 10m5a can be accurately positioned between the photosensitive drum 7 and the developing roller 10d by being attached to the spacer 10m (main body thereof) positioned by the photosensitive drum 7 and the developing roller 10d.

In the present exemplary embodiment, the attaching method of press fitting the cover member 10m5a into the groove 10m6 formed in the spacer 10m is described. However, the attaching method is not limited to this press fitting method, and a method such as bonding may be employed, for example.

Next, a material of the cover member 10m5a as the separate portion will be described.

The cover member 10m5a can be made of any material that can be used for extrusion molding to be mass produced with a smaller thickness compared with the case of the injection molding as described above. For example, the material may be selectable to be the same as or different from the space ensuring member for example.

Specifically, the material of an object made by the extrusion molding includes polyethylene terephthalate, polystyrene, and polypropylene.

### (Configuration, Operation, and Effect of Cover Portion)

An operation and an effect of the cover portion 10m5 will be described.

As illustrated in FIG. 7, the amount of toner carried by the developing roller 10d is not regulated at a portion on the outer side than an end portion of the developing blade 10e, in the longitudinal direction. The toner not pressed by the developing blade 10e is carried by the surface of the developing roller 10d, in an area of the gap Z between the developing blade 10e and the seal member 10g (an area that is on an outer side than the end portion of the developing blade 10e and on an inner side than the seal member 10g, in the longitudinal direction).

The toner not pressed by the developing blade 10e is not appropriately charged by friction. Thus, the toner that is not supposed to be developed on a drum might be developed on the surface of the photosensitive drum 7.

In the present exemplary embodiment, in the cover area C1, the cover portion 10m5 blocks the developing area D in the cross section of the cover portion 10m5 taken along the direction orthogonal to the longitudinal direction, as illustrated in FIG. 6. As further illustrated in FIG. 7, the cover portion 10m5 covers the area C2 including the gap Z between the developing blade 10e and the seal member 10g in the longitudinal direction. Thus, the toner that is not appropriately charged as described above can be prevented from being accidentally transferred onto the photosensitive drum 7.

Thus, the accidental movement of the toner to the photosensitive drum 7 can be prevented by the cover portion 10m5. As a result, the toner does not attach to the end portion of the recording medium 2, whereby the recording medium 2 can be kept clean.

As an effect of the forming the cover portion 10m5 with the different material, a cheaper material such as polystyrene can be selected for the cover portion 10m5. Thus, the component cost can be reduced.

The following effect can be obtained by forming the cover portion 10m5 as the cover member 10m5a that is the separate portion with respect to the spacer 10m. Specifically, the cover member 10m5a can be attached to the spacer 10m even when the smaller distance L2 is set between the closest portions of the photosensitive drum 7 and the developing roller 10d. Thus, the cover portion 10m5 as the cover member 10m5a, which is the separate portion with respect to the spacer 10m, can be made thin. As a result, the distance L2 between the closest portions of the photosensitive drum 7 and the developing roller 10d can be set to be small, and thus can be more freely set.

The cover portion 10m5 as the separate portion can be more freely manufactured. For example, under the current technical level, to obtain the cover portion 10m5 having a thickness in the range between 100 to 200 μm through injection molding, a manufacturer faces a high technical difficulty requiring a high manufacturing cost. On the other hand, it is a common practice to manufacture a sheet with a thickness in such a range through the extrusion molding. Therefore, the cover member 10m5 as a sheet obtained by the extrusion molding can be manufactured at a low cost, whereby the component cost is reduced.

As a further effect of forming the cover portion 10m5 as the cover member 10m5a, which is the separate member with respect to the spacer 10m, the component can be reused. Specifically, the space assuring portion wears and thus cannot be reused after severe wearing. The cover member 10m5a does not wear and thus can be used for multiple times.

When the cover member 10m5a can be shared among multiple models, a further effect that the cover member 10m5a can be reused among multiple models can be achieved.

In the present exemplary embodiment, the cover portion 10m5a covers the entire gap Z (see FIG. 7) between the developing blade 10e and the seal member 10g in the longitudinal direction. Alternatively, the gap Z may be at least partially covered. In this configuration, the toner can be partially prevented from moving from the developing roller 10d to the photosensitive drum 7, whereby a certain level of effectiveness is obtained.

In the present exemplary embodiment, the cover portion 10m5 covers the entire developing area D (see FIG. 6) in the circumferential direction (rotational direction) of the developing roller 10d. Alternatively, the cover portion 10m5 may at least partially cover the developing roller 10d in the developing area D. In this configuration, the amount of toner moving from the developing roller 10d to the photosensitive drum 7 in the developing area D can be reduced.

It is matter of course that, if possible, a configuration where the cover portion 10m5 covers the developing roller 10d in a range entirely including the area of the gap Z of the cover portion 10m5 (see FIG. 7) and the developing area D (see FIG. 6) is most favorable for reducing the amount of toner moving from the developing roller 10d to the photosensitive drum 7. Thus, the range covered by the cover portion 10m5 may be appropriately set in accordance with the level of the fogging in an end portion.

The process cartridge B is not limited to the configuration of forming a monotone image as exemplarily described in the present exemplary embodiment. For example, the process cartridge B may include a plurality of developing units to form a multiple color image (for example, a two color image, a three color image, or a full color image).

In the present exemplary embodiment, the case where the spacer 10m is used in the process cartridge B is described. The developing unit (developing device) 10 including the spacer 10m serves as a part of the process cartridge B.

Alternatively, the developing unit (developing device) 10 can be attached to and detached from the image forming apparatus A separately from the photosensitive drum 7 (the developing unit 10 can be independently attached and detached as the developing cartridge). Furthermore, the developing unit (developing device) 10 may be built in the image forming apparatus A, so as not to be removed from the image forming apparatus A by a user.

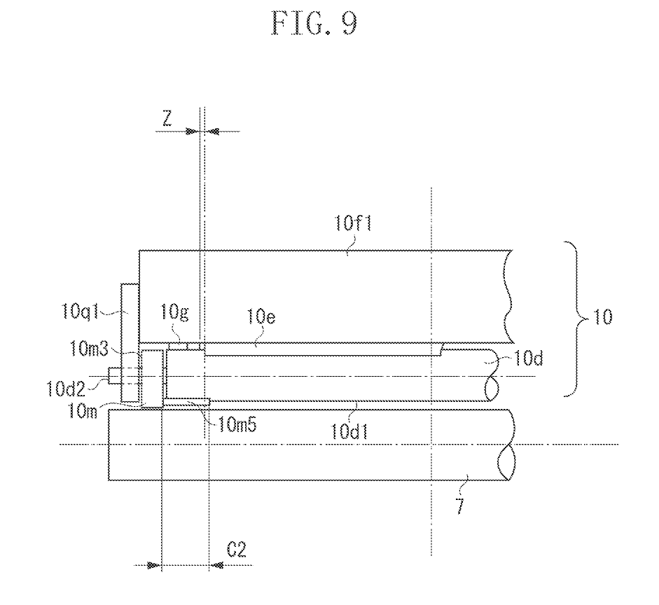

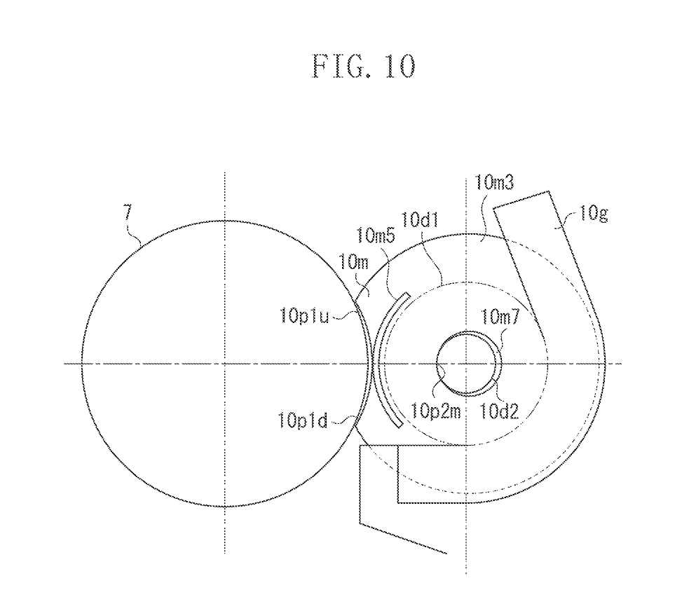

Next, a second exemplary embodiment will be described with reference to FIGS. 9 and 10. The configurations and operations that are the same as those in the first exemplary embodiment will not be described.

In the first exemplary embodiment, the contact portion of the developing roller 10d that comes into contact with the spacer 10m (space ensuring member) is the surface of the large diameter portion 10d1 of the developing roller 10d. In this exemplary embodiment, the small diameter portion 10d2 of the developing roller 10d is set as the contact portion of the developing roller 10d, as illustrated in FIGS. 9 and 10.

Here, the spacer 10m is provided with a hole 10m7 larger than the small diameter portion 10d2 of the developing roller 10d as illustrated in FIG. 10. Thus, in a state where the positioning in the cross-sectional direction is achieved by the contact surfaces 10p1u and 10p1d on the side of the photosensitive drum 7 and the contact surface 10p2m on the side of the developing roller 10d, the small diameter portion 10d2 of the developing roller 10d and the hole 10m7 of the spacer 10m do not interfere with each other. Thus, the space between the photosensitive drum 7 and the developing roller 10d can be appropriately set.

Thus, in the present exemplary embodiment, the maintaining portion that maintains the space between the developing roller 10d and the photosensitive drum 7 has the following configuration. Specifically, the maintaining portion includes a contact surface 10p2m (developing side sliding portion that slides on the small diameter portion 10d2 of the developing roller 10d) formed in the hole 10m7, the contact surface 10p1u (first image bearing member side sliding portion) for the photosensitive drum 7, and the contact surface 10p1d (second image bearing member side sliding portion).

Thus, the maintaining portion of the spacer 10m that maintains the space between the photosensitive drum 7 and the developing roller 10d includes the contact surfaces 10p1u, 10p1d, and 10p2m. The contact surface 10p1u serves as the rotation regulation member that prevents the spacer 10m from moving in the rotational directions (X1 and X2) of the photosensitive drum 7 and the developing roller 10d. The contact surface 10p1u is positioned more on the upstream side than the line la connecting between the rotational centers of the developing roller 10d and the photosensitive drum 7, in the rotational direction X2 of the photosensitive drum 7. The contact surface 10p1u comes into contact with the photosensitive drum 7, and thus the spacer 10m is prevented from moving in the rotational directions X1 and X2 of the developing roller 10d and the photosensitive drum 7.

The present exemplary embodiment can be suitably applied to the cartridge that forms the multiple color image, as is the case of the first exemplary embodiment, and can be applied to the process cartridge and to the developing device.

According to the present invention, the fogging can be prevented from occurring outside the developer regulating member.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-240143 filed Nov. 20, 2013, which is hereby incorporated by reference herein in its entirety.

What is claimed is:

1. A developing device comprising:
a developer bearing member configured to carry a developer for developing a latent image formed on an image bearing member;
a developer regulating member configured to regulate an amount of the developer carried by the developer bearing member; and
a space ensuring member configured to define a space between the image bearing member and the developer bearing member,
wherein the space ensuring member includes
a maintaining unit configured to maintain the space between the image bearing member and the developer bearing member by being in contact with the image bearing member,
a rotation regulating portion configured to prevent the space ensuring member from moving in a rotational direction of the developer bearing member, and
a cover portion disposed to be not in contact with a surface of the developer bearing member and configured to cover a part of the developer bearing member, and
wherein the cover portion is configured to cover at least part of an area in which the developer bearing member faces the image bearing member in the rotational direction of the developer bearing member, the area being on an outer side than an end portion of the developer regulating member in a longitudinal direction of the developer bearing member.

2. The developing device according to claim 1, further comprising:
a frame member configured to contain the developer; and
a seal member configured to prevent the developer from leaking between an end portion of the developer bearing member and the frame member,
wherein the area covered by the cover portion includes an entire range between the developer regulating member and the seal member in the longitudinal direction.

3. The developing device according to claim 1, wherein the rotation regulating portion comes into contact with the image bearing member at a portion more on an upstream side than a straight line connecting between respective rotational centers of the image bearing member and the developer bearing member, in a rotational direction of the image bearing member.

4. The developing device according to claim 1, wherein the area covered by the cover portion includes an entire area in which the developer moves from the developer bearing member to the image bearing member, in the rotational direction of the developer bearing member.

5. The developing device according to claim 1, wherein the cover portion is integrally formed with a main body of the space ensuring member including the maintaining portion.

6. The developing device according to claim 1, wherein the cover portion is formed as a separate portion with respect to a main body of the space ensuring member including the maintaining portion, and is attached to the main body.

7. The developing device according to claim 1, wherein the cover portion is formed of a material different from a material of a main body of the space ensuring member including the maintaining portion.

8. The developing device according to claim 1, wherein the developer bearing member rotates in such a manner that respective facing surfaces of the developer bearing member and the image bearing member move in a same direction.

9. The developing device according to claim 1, wherein
the maintaining portion includes
a first image bearing member side sliding portion configured to slide on the image bearing member at a portion more on an upstream side than a straight line connecting between respective rotational centers of the image bearing member and the developer bearing member, in a rotational direction of the image bearing member,
a second image bearing member side sliding portion configured to slide on the image bearing member at a portion more on a downstream side than the straight line, in the rotational direction of the image bearing member,
a first developing side sliding portion configured to slide on the developer bearing member at a portion more on the upstream side than the straight line, in the rotational direction of the developer bearing member, and
a second developing side sliding portion configured to slide on the developer bearing member at a portion more on the downstream side than the straight line, in the rotational direction of the developer bearing member.

10. The developing device according to claim 1,
wherein the developer bearing member includes a large diameter portion configured to carry the developer and a small diameter portion that has a smaller diameter than the large diameter portion and is rotatably supported by a frame member of the developing device,
wherein the maintaining portion includes
a first image bearing member side sliding portion configured to slide on the image bearing member at a portion more on an upstream side than a straight line connecting between respective rotational centers of the image bearing member and the developer bearing member, in a rotational direction of the image bearing member,
a second image bearing member side sliding portion configured to slide on the image bearing member at a portion more on a downstream side than the straight line in the rotational direction of the image bearing member, and
a developing side sliding portion configured to slide on the small diameter portion.

11. A process cartridge detachably attached to an apparatus main body of an image forming apparatus configured to form an image on a recording medium, the process cartridge comprising:
an image bearing member on which a latent image is formed;
a developer bearing member configured to carry a developer for developing the latent image;
a developer regulating member configured to regulate an amount of the developer carried by the developer bearing member; and
a space ensuring member configured to define a space between the image bearing member and the developer bearing member,
wherein the space ensuring member includes
a maintaining unit configured to maintain the space between the image bearing member and the developer bearing member by being in contact with the image bearing member,
a rotation regulating portion configured to prevent the space ensuring member from moving in a rotational direction of the developer bearing member, and
a cover portion disposed to be not in contact with a surface of the developer bearing member and configured to cover a part of the developer bearing member, and
wherein the cover portion is configured to cover at least part of an area in which the developer bearing member faces the image bearing member in the rotational direction of the developer bearing member, the area being on an outer side than an end portion of the developer regulating member in a longitudinal direction of the developer bearing member.

12. The process cartridge according to claim 11, wherein the developer bearing member is urged toward the image bearing member.

13. The process cartridge according to claim 11, further comprising:
a frame member configured to contain the developer; and
a seal member configured to prevent the developer from leaking between an end portion of the developer bearing member and the frame member,
wherein the area covered by the cover portion includes an entire range between the developer regulating member and the seal member in the longitudinal direction.

14. The process cartridge according to claim 11, wherein the rotation regulating portion comes into contact with the image bearing member at a portion more on an upstream side than a straight line connecting between respective rotational centers of the image bearing member and the developer bearing member, in a rotational direction of the image bearing member.

15. The process cartridge according to claim 11, wherein the area covered by the cover portion includes an entire area in which the developer moves from the developer bearing member to the image bearing member, in the rotational direction of the developer bearing member.

16. The process cartridge according to claim 11, wherein the cover portion is integrally formed with a main body of the space ensuring member including the maintaining portion.

17. The process cartridge according to claim 11, wherein the cover portion is formed as a separate portion with respect to a main body of the space ensuring member including the maintaining portion, and is attached to the main body.

18. The process cartridge according to claim 11, wherein the cover portion is formed of a material different from a material of a main body of the space ensuring member including the maintaining portion.

19. The process cartridge according to claim 11, wherein the developer bearing member rotates in such a manner that respective facing surfaces of the developer bearing member and the image bearing member move in a same direction.

20. An image forming apparatus configured to form an image on a recording medium, the image forming apparatus comprising:
an image bearing member on which a latent image is formed;
a developing device; and
a conveyance mechanism configured to convey the recording medium,
wherein the developing device includes
a developer bearing member configured to carry a developer for developing the latent image;
a developer regulating member configured to regulate an amount of the developer carried by the developer bearing member; and
a space ensuring member configured to define a space between the image bearing member and the developer bearing member,
wherein the space ensuring member includes
a maintaining unit configured to maintain the space between the image bearing member and the developer bearing member by being in contact with the image bearing member,
a rotation regulating portion configured to prevent the space ensuring member from moving in a rotational direction of the developer bearing member, and
a cover portion disposed to be not in contact with a surface of the developer bearing member and configured to cover a part of the developer bearing member, and
wherein the cover portion is configured to cover at least part of an area in which the developer bearing member faces the image bearing member in a rotational direction of the developer bearing member, the area being on an outer side than an end portion of the developer regulating member in a longitudinal direction of the developer bearing member.
